(19) United States
(12) Patent Application Publication
(10) Pub. No.: US 2023/0416478 A1
(43) Pub. Date: Dec. 28, 2023

(54) POLYESTER FILM AND METHOD OF MANUFACTURING SAME

(71) Applicant: SK microworks Co., Ltd., Suwon-si (KR)

(72) Inventors: Byeong Jae LIM, Suwon-si (KR); Young Min HEO, Suwon-si (KR); Chul Kyu KIM, Suwon-si (KR); Ki Youn SONG, Suwon-si (KR)

(73) Assignee: SK microworks Co., Ltd., Suwon-si (KR)

(21) Appl. No.: 18/203,848

(22) Filed: May 31, 2023

(30) Foreign Application Priority Data
Jun. 28, 2022 (KR) 10-2022-0078915

(51) Int. Cl. C08J 5/18; B29C 48/00; B29C 48/08; B29C 48/86

(52) U.S. Cl. CPC C08J 5/18; B29C 48/022; B29C 48/08; B29C 48/872; C08J 2367/02; B29K 2067/00

(57) ABSTRACT

Disclosed is a polyester film comprising a polycyclohexylenedimethylene terephthalate resin having a degree of crystallinity of 36% or less as measured using a differential scanning calorimeter.

### CROSS-REFERENCE TO RELATED APPLICATION

This application claims the benefit under 35 U.S.C. 119(a) of Korean Patent Application No. 10-2022-0078915, filed on Jun. 28, 2022 in the Korean Intellectual Property Office, the disclosure of which is incorporated herein by reference in its entirety.

### BACKGROUND

### 1. Field of the Invention

The present disclosure relates to a polyester film having improved fracture resistance and a method of manufacturing the same.

### 2. Description of Related Art

During manufacture of polyester films, a stretching process is performed at a temperature above a glass transition temperature (Tg). However, since polycyclohexylenedimethylene terephthalate (PCT), which is one of the polyesters, is very rapidly crystallized, it is not easy to control a degree of crystallinity in film applications. Due to the rapid crystal generation, the film may easily be fractured when stretched and wound around a roll.

Therefore, it is necessary to develop an improved method capable of controlling the degree of crystallinity and ensuring fracture resistance during manufacture of PCT films.

The above-described background is technical information that the inventor possessed or acquired for conceiving embodiments of the present disclosure, and cannot necessarily be a known technology disclosed to a general public prior to the filing of the present disclosure.

### SUMMARY OF THE INVENTION

In one general aspect, the polyester film according to an embodiment includes a polycyclohexylenedimethylene terephthalate resin having a degree of crystallinity of 36% or less as measured using a differential scanning calorimeter.

The polyester film may have a machine direction (MD) tear strength of 240 kg/cm or more and 350 kg/cm or less.

The polyester film may have a transverse direction (TD) tear strength of 280 kg/cm or more and 400 kg/cm or less as measured in accordance with ASTM D1004.

The polyester film may have the degree of crystallinity of 33% or less.

The polyester film may have the MD tear strength of 280 kg/cm or more.

The polyester film may have the TD tear strength of 307 kg/cm or more.

The polyester film may have a thickness of 10 μm to 500 μm.

The polycyclohexylenedimethylene terephthalate resin may include a first repeating unit derived from a dicarboxylic acid-based compound and a second repeating unit derived from a diol-based compound.

The first repeating unit may include 80 mol % to 100 mol % of a terephthalic acid residue and 0 mol % to 20 mol % of an isophthalic acid residue.

The second repeating unit may include 85 mol % to 100 mol % of a cyclohexanedimethanol residue.

In another general aspect, the method of manufacturing a polyester film according to another embodiment includes: melting a composition for film manufacturing including a polycyclohexylenedimethylene terephthalate resin and extruding the molten composition to form a sheet; preheating the sheet obtained by the extruding; stretching the sheet obtained by the preheating in a MD to prepare a MD stretched sheet; and stretching the MD stretched sheet in a TD to prepare a TD stretched sheet and thermosetting the TD stretched sheet to manufacture the polyester film, wherein a temperature of the preheating is 80° C. to 87° C. and a temperature of the stretching in the MD is 80° C. to 89° C.

The stretching in the MD may include applying heat using an infrared heater.

The polyester film may have a degree of crystallinity of 36% or less as measured using a differential scanning calorimeter.

The polyester film may have a MD tear strength of 240 kg/cm or more and 350 kg/cm or less and a TD tear strength of 280 kg/cm or more and 400 kg/cm or less as measured in accordance with ASTM D1004.

The composition for film manufacturing may further include an electrostatic pinning agent and an antioxidant.

A temperature of the stretching the MD stretched sheet in the TD may be 100° C. to 125° C.

A temperature of the thermosetting the TD stretched sheet may be 200° C. to 250° C.

A MD stretching ratio of the stretching in the MD may be 2.5 times to 3.5 times and a TD stretching ratio of the stretching in the TD may be 3.3 times to 4.5 times.

The infrared heater may include an upper heater spaced a predetermined distance from a top of the sheet and a lower heater spaced a predetermined distance from a bottom of the sheet.

A surface temperature of the upper heater may be 450° C. to 800° C. and a surface temperature of the lower heater may be 350° C. to 700° C.

Other features and aspects will be apparent from the following detailed description and the claims.

### BRIEF DESCRIPTION OF THE DRAWINGS

FIG. 1 is a diagram related to the tear strength measurement standard of an experimental example.

### DETAILED DESCRIPTION OF EXEMPLARY EMBODIMENTS

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

In the disclosure, when a certain component “includes/comprises” another component, this means that it may further include/comprise other components without excluding other components unless otherwise specified.

In the disclosure, when a component is said to be “connected” to another component, this includes not only the case of being “directly connected,” but also the case of being “connected with another component intervening therebetween.”

In the disclosure, the meaning that B is located on A means that B is located directly on A, or B is located on Awhile another layer is located therebetween, and it is not interpreted as being limited to B being located so as to come into contact with the surface of A.

In the disclosure, the term “combination thereof” included in the expression of the Markush form means a mixture or combination of one or more selected from the group consisting of the components described in the expression of the Markush form, and it means including one or more selected from the group consisting of the above components.

In the disclosure, description of “A and/or B” means “A, B, or A and B.”

In the disclosure, terms such as “first” and “second” or “A” and “B” are used to distinguish the same terms from each other unless otherwise specified.

In the disclosure, a singular expression is interpreted as a meaning including a singular number or a plurality interpreted in the context unless otherwise specified.

It is an object of an embodiment to provide a polyester film having improved fracture resistance.

It is another object of an embodiment to provide a method of manufacturing a polyester film, which minimizes the occurrence of a fracture.

Polyester Film

In order to accomplish the above objective, the polyester film according to an embodiment includes a polycyclohexylenedimethylene terephthalate resin and has a degree of crystallinity of 36% or less as measured using a differential scanning calorimeter.

The polyester film may have, a machine direction (MD) tear strength of 240 kg/cm or more and 350 kg/cm or less, and a transverse direction (TD) tear strength of 280 kg/cm or more and 400 kg/cm or less, wherein the tear strength is measured in accordance with ASTM D1004.

The polycyclohexylenedimethylene terephthalate (PCT) resin of the polyester film may be obtained by copolymerizing a dicarboxylic acid-based compound and a diol-based compound and include residues and repeating units derived therefrom.

The polyester film may include, based on 100 mol % of the repeating unit derived from a dicarboxylic acid-based compound, 80 mol % or more or 90 mol % or more and 100 mol % or less or 99 mol % or less of a terephthalic acid residue and 20 mol % or less or 10 mol % or less and 0 mol % or more, 1 mol % or more, or 2 mol % or more of an isophthalic acid residue.

The polyester film may include, based on 100 mol % of the repeating unit derived from a diol-based compound, 70 mol % or more, 80 mol % or more, or 90 mol % or more and 100 mol % or less of a cyclohexanedimethanol residue.

When the above-described amounts of the terephthalic acid residue and the isophthalic acid residue are included as the repeating unit derived from a dicarboxylic acid-based compound, a relatively high melting point and low crystallinity can be achieved.

The repeating unit derived from a diol-based compound may include a repeating unit derived from the following compound in addition to the cyclohexanedimethanol-derived repeating unit. For example, ethylene glycol, 1,3-propanediol, 1,2-octanediol, 1,3-octanediol, 2,3-butanediol, 1,3-butanediol, 1,4-butanediol, 1,5-pentanediol, 2,2-dimethyl-1,3-propanediol (neopentyl glycol), 2-butyl-2-ethyl-1,3-propanediol, 2,2-diethyl-1,5-pentanediol, 2,4-diethyl-1,5-pentanediol, 3-methyl-1,5-pentanediol, 1,1-dimethyl-1,5-pentanediol, or a residue derived therefrom may be included.

The polycyclohexylenedimethylene terephthalate resin may have a weight-average molecular weight (Mw) of 30,000 g/mol to 50,000 g/mol or 30,000 g/mol to 40,000 g/mol.

In order to enhance the efficiency of polymerization of the polycyclohexylenedimethylene terephthalate resin, a catalyst may be used.

The catalyst may be included in an amount of 0.1 ppm to 500 ppm or 0.5 ppm to 100 ppm based on 100 parts by weight of polycyclohexylenedimethylene terephthalate.

As the catalyst, a titanium-based compound, an antimony-based compound, a germanium-based compound, an aluminum-based compound, or a mixture thereof may be used. For example, the catalyst may be a titanium-based compound. The titanium-based compound may include titanium tetraisopropoxide.

In polymerization of the polycyclohexylenedimethylene terephthalate resin, an antioxidant may be used. The antioxidant may be used to suppress thermal oxidation at a temperature, at which an esterification reaction proceeds as necessary. In this case, an appropriate amount of the antioxidant is generally used. When an excessive amount of the antioxidant is used in polymerization, the reaction may be delayed, and the intrinsic viscosity of a prepared resin may be degraded. The antioxidant that affects resin polymerization is consumed during the polymerization and may be distinguished from an antioxidant to be added in subsequent manufacture of a film.

As the antioxidant, a phenol-based antioxidant, a phosphorus-based antioxidant, a sulfur-based antioxidant, or the like may be included.

The antioxidant may be included in an amount of 0.01 parts by weight to 1 part by weight based on 100 parts by weight of polycyclohexylenedimethylene terephthalate.

In manufacture of a film using the polycyclohexylenedimethylene terephthalate resin, an electrostatic pinning agent may be used. As the electrostatic pinning agent, an alkali-metal salt, an alkaline-earth-metal salt, or the like may be used, and a magnesium-based compound or a calcium-based compound may be used. For example, magnesium acetate, calcium acetate, or the like may be used.

The electrostatic pinning agent may be included so that the electrostatic pinning agent has a metal or metal ion content (wt %) of 300 ppm to 1000 ppm based on 100 parts by weight of the polycyclohexylenedimethylene terephthalate resin.

In the polyester film, a machine direction (MD) is a longitudinal direction parallel to the direction, in which movement is made during a film formation process, and a transverse direction (TD) is a direction perpendicular to the machine direction.

The polyester film may have a degree of crystallinity of 36% or less, 34% or less, 33% or less, or 31.1% or less as measured using a differential scanning calorimeter. The degree of crystallinity may be 10% or more. By having the above-described degree of crystallinity, the polyester film is not easily fractured when wound or applied to a product. Measurement of a degree of crystallinity using a differential scanning calorimeter may be made by a method in an experimental example to be described below.

The polyester film may have a machine direction tear strength of 240 kg/cm or more, 250 kg/cm or more, 270 kg/cm or more, or 280 kg/cm or more. The machine direction tear strength may be 350 kg/cm or less or 340 kg/cm or less.

The polyester film may have a transverse direction tear strength of 280 kg/cm or more, 290 kg/cm or more, 300 kg/cm or more, 307 kg/cm or more, or 331 kg/cm or more. The transverse direction tear strength may be 400 kg/cm or less or 390 kg/cm or less.

By having the above-described machine direction and transverse direction tear strengths, the polyester film is not easily fractured when wound or applied to a product and can secure excellent durability.

The tear strength may be measured in accordance with ASTM D1004 and measured by a method in an experimental example to be described below.

The polyester film may have a thickness of 10 μm to 500 μm or 20 μm to 300 μm.

Since the polyester film is manufactured through a unique low-temperature stretching process in a manufacturing method to be described below, excellent fracture resistance can be exhibited.

Method of Manufacturing Polyester Film

In order to accomplish the above objective, a method of manufacturing a polyester film according to an embodiment includes: melting a film manufacturing composition including a polycyclohexylenedimethylene terephthalate resin and extruding the molten composition to form a sheet (sheet formation step); stretching the sheet obtained by the extrusion in a machine direction (MD stretching step); and stretching the MD stretched sheet in a transverse direction and thermosetting the TD stretched sheet to manufacture a polyester film (TD stretching step), wherein the MD stretching step includes a preheating process of preheating the sheet obtained by the extrusion and a MD stretching process of stretching the preheated sheet in a machine direction, a temperature in the preheating process is 80° C. to 87° C., a stretching temperature in the MD stretching process is 80° C. to 89° C., and the MD stretching step includes a heating process of applying heat to the sheet obtained by the extrusion using an infrared heater.

The film manufacturing composition in the sheet formation step may include an electrostatic pinning agent and an antioxidant. Since descriptions of the electrostatic pinning agent and the antioxidant may be the same as those described above for the polyester film, thus duplicate descriptions are omitted.

The film manufacturing composition may be dried before being melted, and the drying may be performed at a temperature of 150° C. or less or a temperature of 70° C. to 148° C.

The drying of the film manufacturing composition may be performed so that a moisture content is 100 ppm or less or 50 ppm or less relative to the total content. When the drying is performed at a temperature of more than 150° C., unintended color changes may occur in the resin itself.

The film manufacturing composition may have a form of a chip, a pellet, a plate, or the like and have a form that allows the composition to be easily input in a film manufacturing process and effectively mixed.

The polycyclohexylenedimethylene terephthalate resin of the film manufacturing composition may be prepared by a typical polymerization method and prepared, for example, by a polymerization method in the presence of a catalyst containing a metal such as titanium, antimony, or the like.

As described above, the polycyclohexylenedimethylene terephthalate resin of the film manufacturing composition may be obtained by copolymerizing a dicarboxylic acid-based compound and a diol-based compound and include repeating units derived therefrom.

The extrusion in the sheet formation step may be performed at a temperature of 230° C. to 300° C. or a temperature of 250° C. to 290° C.

The preheating process in the MD stretching step may be performed by thermally treating the sheet at a temperature of 80° C. to 87° C. for 0.5 seconds to 2 minutes or at a temperature of 80° C. to 86° C. for the same time.

The MD stretching process in the MD stretching step may be performed by stretching the preheated sheet 2.5× to 3.5× in a machine direction at a temperature of 80° C. to 89° C. or by stretching the preheated sheet at the same ratio in a machine direction at a temperature of ° C. to 87° C. or a temperature of 80° C. to 85° C.

The MD stretching step may include a heating process using an infrared heater provided to be spaced 30 mm to 200 mm from the top and/or bottom of the preheated unstretched sheet. A surface temperature of the infrared heater provided at the top of the unstretched sheet may be 450° C. to 800° C. or 500° C. to 700° C.

The MD stretching step may allow a manufactured film to satisfy desired fracture resistance through the preheating process and the MD stretching process.

The TD stretching step may be performed by stretching the MD stretched sheet 3.3× to 4.5× in a transverse direction at a temperature of 100° C. to 125° C. or by stretching the MD stretched sheet at the same ratio in a transverse direction at a temperature of 102° C. to 115° C. or 105° C. to 112° C.

The TD stretching step may further include performing preheating before stretching. The preheating in the TD stretching step may be performed at a temperature of 90° C. to 108° C. for 0.5 seconds to 5 minutes and performed several times by adjusting the temperature to rise or fall in the range of 0.1° C. to 5° C.

The thermosetting in the TD stretching step may be performed at a temperature of 200° C. to 250° C. for 5 seconds to 600 seconds or 10 seconds to 200 seconds.

The film manufactured by the TD stretching step may be relaxed in a longitudinal direction and/or a transverse direction, a relaxation temperature may be 150° C. to 250° C., and a relaxation rate may be 1% to 10% or 3% to 7%.

Hereinafter, the present invention will be described in detail with reference to specific examples. However, the following examples are merely presented to promote understanding of the present invention, and the scope of the present invention is not limited thereto.

### Example 1

A monomer mixture including 100 mol % of cyclohexanedimethanol (CHDM) as a diol-based compound and 96 mol % of terephthalic acid (TPA) and 4 mol % of isophthalic acid (IPA) as dicarboxylic acid-based compounds was input into a stirrer, a titanium catalyst was input in an amount of 1 ppm based on 100 parts by weight of the mixture, and then a transesterification reaction was performed at 285° C.

The material obtained by the transesterification reaction was transferred to a separate reactor equipped with vacuum equipment and then polymerized at 290° C. for 160 minutes to obtain a polycyclohexylenedimethylene terephthalate (PCT) resin.

98 wt % of a chip including the PCT resin and 2 wt % of a chip including an antioxidant and an electrostatic pinning agent were processed to form a master batch chip, and the master batch chip was dried at a temperature of 140° C. Then, the resulting material was input into an extruder and extruded at a temperature of about 295° C. to form a sheet, and the sheet was casted using a casting roll.

The extruded sheet was preheated at a temperature of 80° C. for 10 seconds and then stretched 3.2× in a machine direction (MD) at a temperature of 80° C. In the MD stretching, a heating process using an infrared heater provided to be spaced 80 mm from the top and bottom of the sheet was additionally performed. In this case, a surface temperature of the upper heater was set to 500° C., and a surface temperature of the lower heater was set to 400° C. Afterward, the MD stretched sheet was stretched 3.5× in a transverse direction (TD) at a temperature of 110° C. Then, the stretched sheet was thermoset at a temperature of 230° C. for about 30 seconds and relaxed to manufacture a 40 μm-thick PCT film.

### Example 2

A PCT film was manufactured in the same manner as in Example 1, except that a surface temperature of the upper heater was changed to 700° C., and a surface temperature of the lower heater was changed to 600° C.

### Example 3

A PCT film was manufactured in the same manner as in Example 1, except that temperatures of preheating before MD stretching and MD stretching were changed to 85° C.

### Example 4

A PCT film was manufactured in the same manner as in Example 1, except that a surface temperature of the upper heater was changed to 700° C., a surface temperature of the lower heater was changed to 600° C., and temperatures of preheating before MD stretching and MD stretching were changed to 85° C.

### Comparative Example 1

A PCT film was manufactured in the same manner as in Example 1, except that temperatures of preheating before MD stretching and MD stretching were changed to 95° C.

### Comparative Example 2

A PCT film was manufactured in the same manner as in Example 1, except that temperatures of preheating before MD stretching and MD stretching were changed to 95° C., a surface temperature of the upper heater was changed to 700° C., and a surface temperature of the lower heater was changed to 600° C.

### Experimental Example 1—Measurement of Degree of Crystallinity

The degree of crystallinity of the films manufactured in Examples and Comparative Examples was measured using a differential scanning calorimeter (DSC-Q2000 commercially available from TA instruments). Specifically, 5 mg of each film sample obtained in Examples and Comparative Examples was placed in an aluminum pan, compressed, and then sealed. The resultant was heated in a reaction furnace while raising a temperature at a rate of ° C./min from room temperature to 350° C., cooled to −70° C., and heated again at a rate of ° C./min to room temperature. When the phase transition of the sample occurred, the degree of heat absorption and heat release was confirmed by the amount of current using the platinum resistor sensor of the reaction furnace, enthalpy was applied to the following equation to calculate a degree of crystallinity, and results thereof are shown in Table 1.

Degree of crystallinity (%)=(ΔH/ΔHO)×100%

wherein ΔH represents the heat of fusion (J/g) of the prepared PCT copolymer, and ΔHO represents the heat of fusion of the PCT resin having a degree of crystallinity of 100%.

### Experimental Example 2—Measurement of Tear Strength

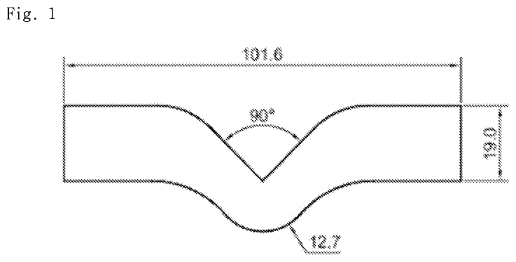

A sample was prepared using each film manufactured in Examples and Comparative Examples according to ASTM D1004 standard. As shown in FIG. 1, the sample was shaped so as to satisfy a size of 101.6 mm×19.0 mm and have a right-angled groove in the center. The tear strength of the sample was measured at a tensile rate of 100 mm/min using UTM 4520 commercially available from Instron, and results thereof are shown in Table 1.

### Experimental Example 3—Measurement of Fracture Property

In the TD stretching in the manufacturing process of Examples and Comparative Examples, a case in which the degree of fracture was good was indicated as ∘, and a case in which there was a fracture was indicated as x. Also, a fracture resistance score when the film was wound around a winder was measured by deducting 0.5 points from a perfect score of 10 points whenever a fracture occurred for the number of times of winding, and results thereof are shown in Table 1.

TABLE 1

| | | Temperature of | | | | | Fracture |
|---|---|---|---|---|---|---|---|
| | MD preheating | upper/lower | | | | | property in |
| | and stretching | infrared | Degree of | MD tear | TD tear | TD | winding |
| | temperature | heaters | crystallinity | strength | strength | fracture | around |
| Classification | (° C.) | (° C.) | (%) | (kg/cm) | (kg/cm) | property | winder |
| Comparative | 95 | 500/400 | 41.7 | 220.40 | 296.84 | x | 2.0 |
| Example 1 | | | | | | | |
| Comparative | 95 | 700/600 | 21.6 | 192.37 | 268.81 | x | 1.5 |
| Example 2 | | | | | | | |
| Example 1 | 80 | 500/400 | 31.1 | 280.28 | 331.24 | ∘ | 9.5 |
| Example 2 | 80 | 700/600 | 22.0 | 257.64 | 300.45 | ∘ | 8.5 |
| Example 3 | 85 | 500/400 | 33.0 | 281.55 | 307.34 | ∘ | 9.0 |
| Example 4 | 85 | 700/600 | 26.6 | 248.41 | 289.38 | ∘ | 8.0 |

Referring to Table 1, it can be confirmed that Examples, in which MD preheating and stretching processes were performed at a relatively low temperature, exhibited low degrees of crystallinity and excellent MD and TD tear strength, and even when winding was performed several times, fracture resistance was good.

The polyester film according to an embodiment can be applied in various fields due to having a relatively low degree of crystallinity and excellent fracture resistance.

The method of manufacturing a polyester film according to an embodiment can manufacture a polyester film having a low degree of crystallinity and excellent fracture resistance through low-temperature machine direction stretching and preheating processes.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A polyester film comprising a polycyclohexylenedimethylene terephthalate resin having a degree of crystallinity of 36% or less as measured using a differential scanning calorimeter,
wherein the polyester film has a machine direction (MD) tear strength of 240 kg/cm or more and 350 kg/cm or less,
wherein the polyester film has a transverse direction (TD) tear strength of 280 kg/cm or more and 400 kg/cm or less as measured in accordance with ASTM D1004.

2. The polyester film of claim 1, wherein the polyester film has the degree of crystallinity of 33% or less.

3. The polyester film of claim 1, wherein the polyester film has the MD tear strength of 280 kg/cm or more.

4. The polyester film of claim 1, wherein the polyester film has the TD tear strength of 307 kg/cm or more.

5. The polyester film of claim 1, wherein the polyester film has a thickness of 10 μm to 500 μm.

6. The polyester film of claim 1, wherein the polycyclohexylenedimethylene terephthalate resin may comprises a first repeating unit derived from a dicarboxylic acid-based compound and a second repeating unit derived from a diol-based compound.

7. The polyester film of claim 6, wherein the first repeating unit comprises 80 mol % to 100 mol % of a terephthalic acid residue and 0 mol % to 20 mol % of an isophthalic acid residue.

8. The polyester film of claim 6, wherein the second repeating unit comprises 85 mol % to 100 mol % of a cyclohexanedimethanol residue.

9. A method of manufacturing a polyester film comprising:
melting a composition for film manufacturing comprising a polycyclohexylenedimethylene terephthalate resin and extruding the molten composition to form a sheet;
preheating the sheet obtained by the extruding;
stretching the sheet obtained by the preheating in a MD to prepare a MD stretched sheet; and
stretching the MD stretched sheet in a TD to prepare a TD stretched sheet and thermosetting the TD stretched sheet to manufacture the polyester film,
wherein a temperature of the preheating is 80° C. to 87° C. and a temperature of the stretching in the MD is 80° C. to 89° C.

10. The method of claim 9, wherein the stretching in the MD comprises applying heat using an infrared heater.

11. The method of claim 9, wherein the polyester film has a degree of crystallinity of 36% or less as measured using a differential scanning calorimeter.

12. The method of claim 9, wherein the polyester film has a MD tear strength of 240 kg/cm or more and 350 kg/cm or less and a TD tear strength of 280 kg/cm or more and 400 kg/cm or less as measured in accordance with ASTM D1004.

13. The method of claim 9, wherein the composition for film manufacturing further comprises an electrostatic pinning agent and an antioxidant.

14. The method of claim 9, wherein a temperature of the stretching the MD stretched sheet in the TD is 100° C. to 125° C.

15. The method of claim 9, wherein a temperature of the thermosetting the TD stretched sheet is 200° C. to 250° C.

16. The method of claim 9, wherein a MD stretching ratio of the stretching in the MD is 2.5 times to 3.5 times and a TD stretching ratio of the stretching in the TD is 3.3 times to 4.5 times.

17. The method of claim 10 wherein the infrared heater comprises an upper heater spaced a predetermined distance from a top of the sheet and a lower heater spaced a predetermined distance from a bottom of the sheet.

18. The method of claim 17, wherein a surface temperature of the upper heater is 450° C. to 800° C. and a surface temperature of the lower heater is 350° C. to 700° C.
